(19) United States
(12) Patent Application Publication
(10) Pub. No.: US 2013/0046735 A1
(43) Pub. Date: Feb. 21, 2013

(54) MAIL SAVING-AND-BACK-UP SYSTEM AND BACKUP METHOD

(71) Applicants: GEN TSUCHIDA, Yokohama (JP); Yoshiteru Takeshima, Tokyo (JP); Masafumi Kinoshita, Sagamihara (JP)

(72) Inventors: GEN TSUCHIDA, Yokohama (JP); Yoshiteru Takeshima, Tokyo (JP); Masafumi Kinoshita, Sagamihara (JP)

(73) Assignee: Hitachi, Ltd.

(21) Appl. No.: 13/372,186

(22) Filed: Feb. 13, 2012

(30) Foreign Application Priority Data
Feb. 14, 2011 (JP) 2011-028855

(51) Int. Cl. G06F 17/30

(52) U.S. Cl. 707/652; 707/E17.005

(57) ABSTRACT

A mail saving-and-backup system including a mail server and backup servers performs a backup method. The mail server determines the degree of importance of a received email by reference to a mail-importance determination table. Subsequently, the mail server determines the number of one or more backup servers for use in saving the email, according to the degree of importance of the email by reference to a backup-server management table, in which information on the status of each of the backup servers is stored. Then, the mail server selects one or more of the backup servers for use in saving the email. The mail server sends the email to each of the selected one or more of the backup servers. Then, each of the selected one or more of the backup servers stores the email in a memory.

### CROSS REFERENCE TO RELATED APPLICATION

This application claims the foreign priority benefit under 35 U.S.C. §119 of Japanese Patent Application No. 2011-028855, filed on Feb. 14, 2011, the disclosure of which is incorporated herein by reference.

### BACKGROUND

The subjects disclosed in this specification relate to a mail saving-and-backup system and a backup method.

As a technique for saving electronic mails (which are hereinafter referred to as emails) in a mail system, a method of backing up the emails in a storage device (e.g., a hard disk drive) arranged in a mail server has been disclosed, for example, in Japanese Patent Laid-open No. 2002-351719 (which is hereinafter referred to as JP2002-351719A), paragraph No. 0008 and FIG. 1, where the mail system receives emails from an external server, saves the received emails in the mail system, and sends each email to a communication terminal when the communication terminal requests the sending of the email. Alternatively, a method of arranging a backup server separately from the mail server and backing up the emails in a storage device (e.g., a hard disk drive) arranged in the backup server has been disclosed, for example, in Japanese Patent Laid-open No. 2007-274053 (which is hereinafter referred to as JP2007-274053A), paragraph No. 0012 and FIG. 1.

The storage device used for backing up the emails may be a Hard Disk Drive (HDD), a Flash memory-based Solid-State Drive (Flash SSD), a volatile memory (e.g., a Random Access Memory (RAM)) mounted in the server, or other types of storage devices. With the recent increase in the capacities of the memory devices mounted in servers and the decrease in the prices of the memory devices, data saving in a memory device in a server (without use of the hard disk drive as in the conventional servers) is becoming a reality. (See, for example, in Japanese Patent Laid-open No. 2006-139696 (which is hereinafter referred to as JP2006-139696A), paragraphs Nos. 0009 and 0010.)

In the memory-based backup systems in which emails are saved in a memory device being arranged in a backup server and not using a mechanically moving element which causes latency, the disk I/O (input/output) time for email saving is short compared with disk I/O (input/output) time in the conventional system using a hard disk drive, and it is possible to achieve the processing speed approximately ten times higher than the conventional system (which uses a hard disk drive).

However, when the server fails, data is more likely to be lost in the memory-based backup systems than in the hard disk-based backup systems. Therefore, in order to prevent the data loss which can be caused by the server failure, enhancement of the failure tolerance by use of multiple backup servers is required.

Incidentally, the emails saved in the mail system include important emails and less necessary emails. The important emails are wanted by the recipients to be preferentially saved, the necessity of saving the less necessary emails is low, and the less necessary emails include spam emails (which are emails unsolicitedly sent in large numbers).

U.S. Pat. No. 6,826,665 (which is hereinafter referred to as U.S. Pat. No. 6,826,665) discloses a technique of arranging multiple storage mediums in a server which receives data, and changing the storage medium which backs up the data, according to the degree of importance of the data, by storing high priority data (which are requested by a user to be preferentially saved) in a highly reliable storage medium.

However, in the case where memory devices in multiple backup servers are used for email backup according to the conventional techniques mentioned before, the following problems can occur.

In JP2002-351719A and JP2007-274053A, it is assumed that the backup is made by using a single storage medium. Therefore, the techniques disclosed in JP2002-351719A and JP2007-274053A cannot be directly applied to a system having multiple backup storage devices.

In the case where the technique disclosed in U.S. Pat. No. 6,826,665 is applied to a mail backup system, one of multiple storage mediums respectively having different degrees of reliability, which is appropriate for use in backup of each email required to be saved, can be selected according to the degree of importance of the email, so that each email can be backed up in the storage medium appropriate for the email. Nevertheless, since only one of the multiple storage mediums is selected according to the technique disclosed in U.S. Pat. No. 6,826,665, each email is backed up in only one storage medium, so that the technique disclosed in U.S. Pat. No. 6,826,665 cannot improve the failure tolerance. Further, in the case where the multiple storage mediums are hard disk drives, it is difficult to increase the processing speed as in the case where the emails are saved in memory devices which do not use a mechanically moving element.

In the technique disclosed in JP2006-139696A, data is backed up in a memory device. Generally, the storage capacity per unit cost of the memory device not using a mechanically moving element is smaller than the storage capacity per unit cost of the hard disk drive. Therefore, in the case where email data are simply saved in memory devices in multiple backup servers by using the technique disclosed in JP2006-139696A, the efficiency in email storage in the backup server is lowered, so that the mail backup can become difficult.

In view of the above circumstances, this specification discloses a mail saving-and-backup system and a backup method which can enhance the efficiency in email storage while ensuring the failure tolerance in email saving.

### SUMMARY

The mail saving-and-backup system disclosed in this specification includes a mail server and a plurality of backup servers. The mail server determines the degree of importance of a received email by reference to a mail-importance determination table. Subsequently, the mail server determines the number of one or more backup servers for use in saving the received email according to the degree of importance of the received email by reference to backup-server management information in a backup-server management table, in which information on the status of each of the plurality of backup servers is stored. Then, the mail server selects one or more of the plurality of backup servers for use in saving the received email. Thereafter, the mail server sends the received email to each of the one or more selected backup servers. Then, each of the one or more selected backup servers stores the received email in a memory.

The mail saving-and-backup system and the backup method which are disclosed in this specification can enhance the efficiency in email storage while ensuring the failure tolerance in email saving.

### BRIEF DESCRIPTION OF THE DRAWINGS

FIG. 1 is a function block diagram illustrating an example of a construction of a mail system according to an embodiment disclosed in this specification;

FIG. 2 is a diagram illustrating an example of a data structure of a backup-server management table used in the embodiment;

FIG. 3 is a diagram illustrating an example of a format of an importance-determination request in the embodiment;

FIG. 4 is a diagram illustrating an example of a format of an importance-determination reply in the embodiment;

FIG. 5 is a diagram illustrating an example of a format of mail-server-saved mail information (information on emails saved in a mail server) in the embodiment;

FIG. 6 is a diagram illustrating an example of a format of a mail-save request in the embodiment;

FIG. 7 is a diagram illustrating an example of a format of a mail-save reply in the embodiment;

FIG. 8 is a diagram illustrating an example of a format of a mail-delete request in the embodiment;

FIG. 9 is a diagram illustrating an example of a format of a mail-delete reply in the embodiment;

FIG. 10 is a diagram illustrating an example of a data structure in a mail-importance determination table used in the embodiment;

FIG. 11 is a diagram illustrating an example of a format of backup-server-saved mail information (information on emails saved in backup servers) in the embodiment;

FIG. 12 is a flow diagram indicating a flow of operations in backup-server determination processing performed by a mail-server processing unit in the mail server in the embodiment;

FIG. 13 is a flow diagram indicating a flow of operations in mail-importance determination processing performed by a mail-importance determination unit in the mail server in the embodiment; and

FIG. 14 is a sequence diagram indicating a sequence of operations performed in the entire mail system in the embodiment.

### DETAILED DESCRIPTION OF THE EMBODIMENT

### 1. Mail System

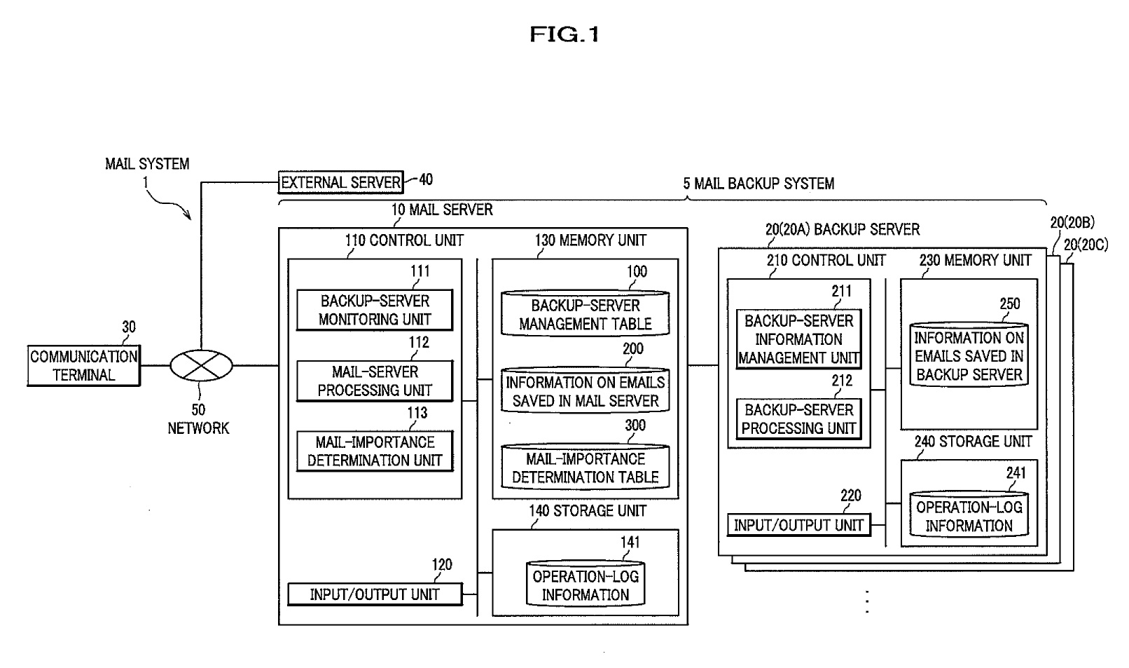

The mail system 1 having the mail saving-and-backup system 5 according to the embodiment is explained below with reference to FIG. 1, which illustrates an example of a construction of the mail system according to the present embodiment.

In the mail system 1, a mail server 10, a communication terminal 30, and an external server 40 are connected through a network 50. In addition, a plurality of backup servers 20A, 20B, 20C . . . (which may be hereinafter collectively referred to as the backup servers 20) are communicatively connected to the mail server 10. The mail server 10 and the backup servers 20 constitute the mail saving-and-backup system 5. Although only the communication terminal 30 and only the external server 40 are illustrated in FIG. 1, further communication terminals (not shown) and further external servers (not shown) are connected to the mail server 10 through the network 50. In addition, although only the three backup servers 20A, 20B, and 20C are illustrated in FIG. 1, the number of the backup servers 20 is not limited to three. The number of the backup servers 20 can be any number greater than one.

The communication terminal 30 and other communication terminals (not shown) are connected to the mail server 10 through the network 50, and perform operations of transmission and reception of emails to and from the mail server 10. The external server 40 receives emails transmitted from other communication terminals (not shown) accommodated by the external server 40 and emails transmitted through other external servers (not shown), and transmits emails addressed to the communication terminals accommodated by the mail server 10 (such as the communication terminal 30), to the mail server 10 through the network 50. The network 50 is realized by, for example, a WAN (wide area network) or a LAN (local area network), or the like.

### 2. Mail Server

The mail server 10 receives the emails addressed to the communication terminals accommodated by the mail server 10 (including the communication terminal 30), and determines the degree of importance of each of the received emails by reference to the mail-importance determination table 300 (which is explained later in detail). Then, the mail server 10 refers to the backup-server management table 100 (which is explained later in detail), determines the number of one or more backup servers for use in saving of the email according to the determined degree of importance of the email, and selects one or more of the backup servers 20 for use in saving of the email. Subsequently, the mail server 10 sends each of the received emails to the one or more selected backup servers together with a mail-save request 500 (which is explained later in detail).

When the mail server 10 receives a mail-send request for an email, from one of the communication terminals accommodated by the mail server 10 (e.g., the communication terminal 30), the mail server 10 transmits the email, which is saved in the mail server 10 or the one or more of the backup servers 20 selected as above, to the one of the communication terminals accommodated by the mail server 10.

The mail server 10 includes a control unit 110, an input/output unit 120, a memory unit 130, and a storage unit 140.

The control unit 110 includes a backup-server monitoring unit 111, a mail-server processing unit 112, a mail-importance determination unit 113, and controls all the operations for transmission, reception, and backup of emails.

The backup-server monitoring unit 111 monitors and acquires information for use as indexes in the selection of the one or more of the backup servers 20, where the information includes the connection status, memory usage, and the like of each of the backup servers 20. The backup-server monitoring unit 111 stores the acquired information in the backup-server management table 100 in the memory unit 130.

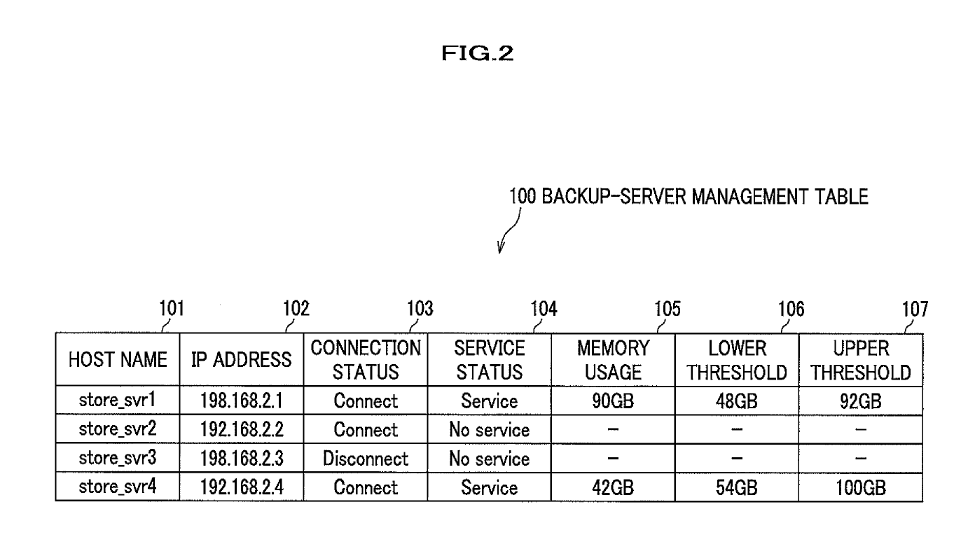

FIG. 2 illustrates an example of a data structure of backup-server management information in the backup-server management table 100.

The backup-server management table 100 contains, for each of the backup servers 20, the fields of the host name 101, the IP address 102, the connection status 103, the service status 104, the memory usage 105, the lower threshold 106, and the upper threshold 107.

In the field of the host name 101, the host name or the domain name of each of the backup servers 20 is stored. In the field of the IP address 102, the IP address of each of the backup servers 20 is stored. In the field of the connection status 103, status information indicating whether or not communication between the mail server 10 and each of the backup servers 20 is possible is stored. Specifically, the status information in the field of the connection status 103 indicates “Connect” when communication between the mail server 10 and each of the backup servers 20 is possible, and “Disconnect” when communication between the mail server 10 and each of the backup servers 20 is not possible.

In the field of the service status 104, status information indicating whether or not the functions for backing up emails in each of the backup servers 20 are operating, i.e., whether or not each of the backup servers 20 is usable, is stored. The functions for backing up emails in each of the backup servers 20 are realized by a backup-server information management unit 211 and a backup-server processing unit 212 as explained later. Specifically, the status information in the field of the service status 104 indicates “Service” when the functions for backing up emails in each of the backup servers 20 are operating, and “No Service” when the functions for backing up emails in each of the backup servers 20 are not operating.

In the field of the memory usage 105, information indicating the current memory usage in each of the backup servers 20 is stored.

The connection status 103, the service status 104, and the memory usage 105 can be included in the “information on current status” referred to in the appended claims, where the “information on current status” is information indicating the current operational status of each of the backup servers 20.

In the fields of the lower threshold 106 and the upper threshold 107, the lower threshold and the upper threshold of the memory usage in each of the backup servers 20 are stored. The lower threshold 106 and the upper threshold 107 are stored in advance in a storage unit 240 in each of the backup servers 20, for example, by reading a configuration (config) file and setting values in the storage unit 240 when each of the backup servers 20 is started up. The lower threshold 106 is a threshold for determining whether or not the memory usage in each of the backup servers 20 is sufficiently smaller than the total memory capacity in the backup server, i.e., whether or not the available space in the memory in each of the backup servers 20 is sufficient. The upper threshold 107 is a threshold for determining whether or not the memory usage in each of the backup servers 20 is considerably close to the total memory capacity in the backup server, i.e., whether or not the available space in the memory in each of the backup servers 20 is insufficient. The lower threshold 106 and the upper threshold 107 are referred to when (the mail-server processing unit 112 in) the mail server 10 determines the number of one or more backup servers for use in backup of each email.

When each of the backup servers 20 is started up, the backup-server monitoring unit 111 collects information including the host name 101, the IP address 102, the lower threshold 106, and the upper threshold 107 from the backup-server information management unit 211 in each of the backup servers 20, and stores the collected information in the backup-server management table 100 (illustrated in FIG. 2). Thus, the backup-server monitoring unit 111 monitors the current status of each of the backup servers 20 by collecting information including the connection status 103, the service status 104, and the memory usage 105 from the backup-server information management unit 211 in each of the backup servers 20 at predetermined intervals.

Alternatively, the backup-server monitoring unit 111 may acquire information on the available total memory capacity in each of the backup servers 20 and store the acquired information in the backup-server management table 100 when each of the backup servers 20 is started up. In this case, the mail server 10 can obtain the currently available memory capacity in each of the backup servers 20 by calculating the difference between the total memory capacity and the memory usage 105 in each of the backup servers 20. In addition, the mail server 10 can calculate the proportion of the memory usage to the total memory capacity, and use the proportion as an index for selection of one or more of the backup servers 20.

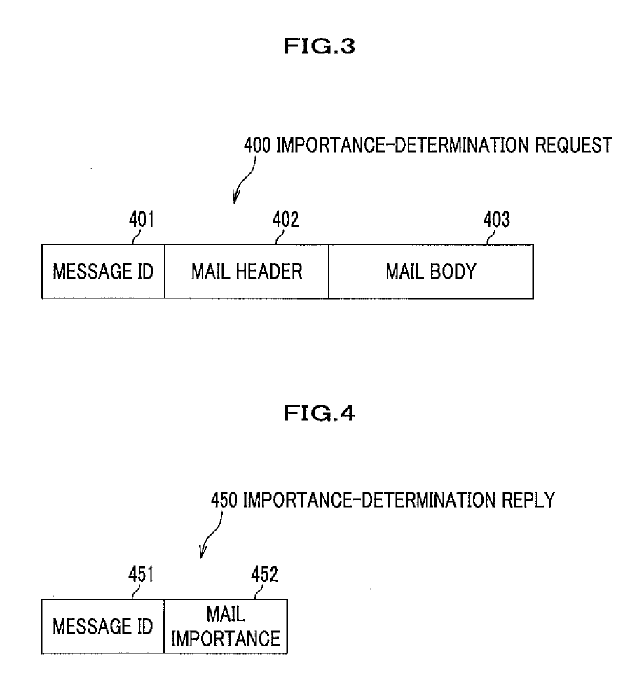

Referring back to FIG. 1, when the mail-server processing unit 112 receives an email through the external server 40, the network 50, and the input/output unit 120, the mail-server processing unit 112 outputs an importance-determination request 400 (as illustrated in FIG. 3) to the mail-importance determination unit 113, where the importance-determination request 400 is a request for determination of the degree of importance of the received email. Thereafter, the mail-server processing unit 112 acquires an importance-determination reply 450 (as illustrated in FIG. 4) from the mail-importance determination unit 113, where a result of the determination of the degree of importance of the email is contained in the importance-determination reply 450.

The degree of importance of the email is an index indicating whether or not each email is requested by a user to be preferentially saved. In the present embodiment, the degree of importance of emails is classified into three degrees, “Important”, “Spam”, and “General”. The emails having the degree of importance “Important” are requested to be preferentially saved (i.e., are more strongly needed to be saved than the emails having the degree of importance “General”). The emails having the degree of importance “Spam” are spam emails, which are less strongly needed to be saved than the emails having the degree of importance “General”. Thus, the emails the importance of which is neither “Important” nor “Spam” are classified as having the degree of importance “General”. The degree of importance is determined by the mail-importance determination unit 113. Although the degrees of importance of emails are classified into the three degrees in the present embodiment, the number of degrees to which the importance of emails is classified may be different from three, and may be, for example, four or more.

FIG. 3 illustrates an example of a format of the importance-determination request 400 in the present embodiment, and FIG. 4 illustrates an example of a format of the importance-determination reply 450 in the present embodiment.

As illustrated in FIG. 3, the format of the importance-determination request 400 includes the fields of a message ID 401, a mail header 402, and a mail body 403. The field of the message ID 401 contains a message ID of an email the importance of which is requested to be determined.

The message ID 401 is, for example, the Message-ID contained in the mail header, which is a number unique to each email. Although, in the present embodiment, it is assumed that the Message-ID contained in the mail header is used as the message ID 401, alternatively, the mail server 10 may be configured in such a manner that the mail-server processing unit 112 assigns as the message ID 401 an ID unique to each email. The field of the mail header 402 contains header information including the mail address, the IP address, and the domain name of the source of each email, the IP address and the domain name of each server through which each email passes, the mail address of the destination, and the like. The field of the mail body 403 contains the mail body of each email.

As illustrated in FIG. 4, the format of the importance-determination reply 450 includes the fields of a message ID 451 and a degree of importance 452. The field of the message ID 451 contains the Message-ID, which is identical to the message ID 401. The field of the degree of importance 452 contains the degree of importance, “Important”, “Spam”, or “General”, which is determined by the mail-importance determination unit 113 to indicate the importance of the corresponding email.

Further, the mail-server processing unit 112 has the following functions.

The mail-server processing unit 112 determines the number of one or more backup servers for use in saving of each email, and one or more of the backup servers 20 for use in saving of the email, by using the degree of importance of the email which is contained in the importance-determination reply 450 received from the mail-importance determination unit 113 and the information on the backup servers 20 which is stored as the backup-server management table 100 (illustrated in FIG. 2) in the memory unit 130.

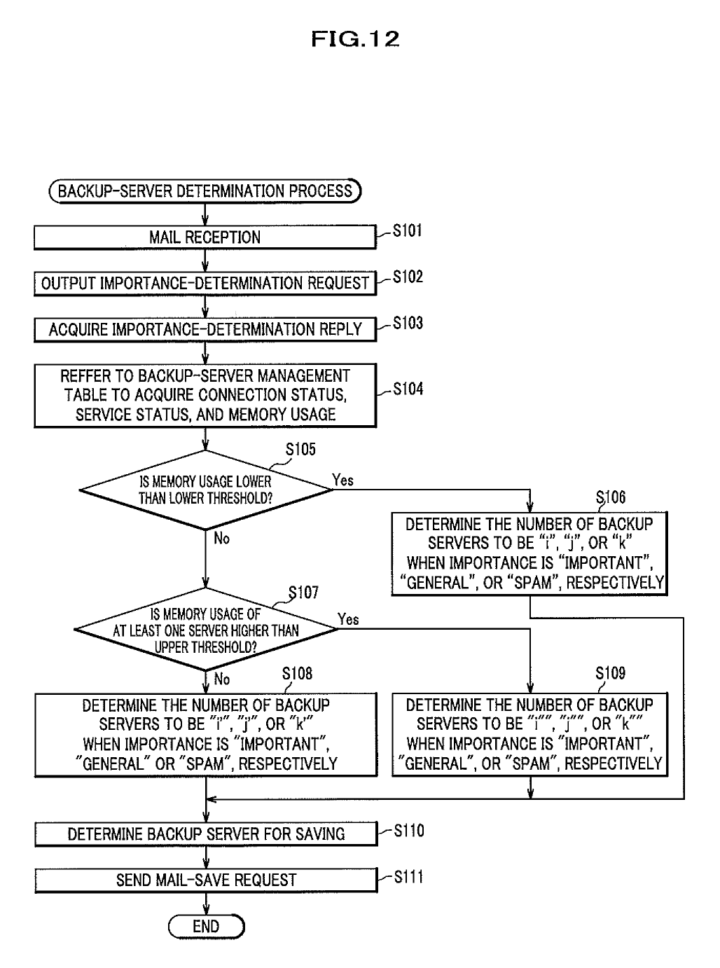

Specifically, the mail-server processing unit 112 refers to the backup-server management table 100, and extracts all or part of the backup servers 20 which can currently back up the above email, where each of the backup servers which can currently back up the email has the connection status 103 of “Connect” and the service status 104 of “Service”. Then, the mail-server processing unit 112 determines the number of one or more backup servers which are to save the email, by determining whether or not the memory usage 105 in each of the extracted backup servers falls below the lower threshold 106 or exceeds the upper threshold 107 (as explained in detail later with reference to FIG. 12). Subsequently, the mail-server processing unit 112 selects, as one or more backup servers for use in saving the email, one or more of the backup servers 20 in the determined number in increasing order of the memory usage 105.

Alternatively, in the case where the total memory capacity in each of the backup servers 20 is additionally stored in the backup-server management table 100, and therefore the available memory capacity in each of the backup servers 20 or the proportion of the memory usage to the total memory capacity can be calculated, it is possible to select one or more of the backup servers 20 in decreasing order of the available memory capacity, in increasing order of the proportion of the memory usage, or in a similar order.

Hereinafter, the processing for determining the number of one or more backup servers for use in saving each email and selecting one or more of the backup servers 20 for use in saving each email is referred to as backup-server determination processing, and will be explained in detail later with reference to FIG. 12.

The mail-server processing unit 112 stores information on the received email as mail-server-saved mail information 200 in the memory unit 130. The mail-server-saved mail information 200 is information on emails saved in the mail server. In addition, the mail-server processing unit 112 accesses the mail-server-saved mail information 200 in order to refer to an email (i.e., in order to transmit a saved email in response to a request from a communication terminal such as the communication terminal 30), or in order to delete a saved email.

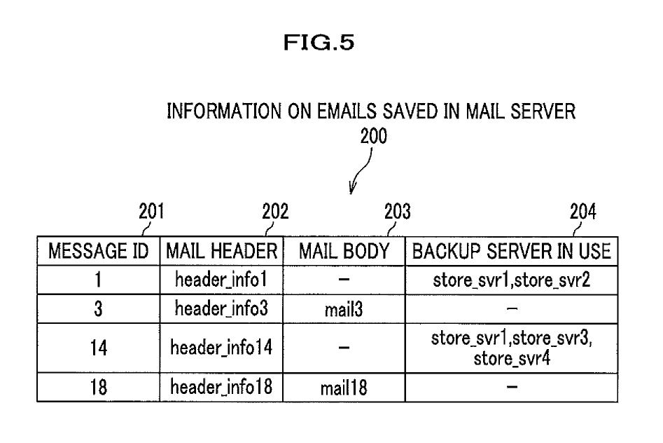

FIG. 5 illustrates an example of a format of the mail-server-saved mail information 200 in the present embodiment. The mail-server-saved mail information 200 contains a record for each of the received emails, and each record is constituted by the fields of a message ID 201, a mail header 202, a mail body 203, and a backup server in use 204.

The message ID 201, the mail header 202, and the mail body 203 are information items which the mail-server processing unit 112 stores as part of the mail-server-saved mail information 200 when the mail server 10 receives an email. The message ID 201, the mail header 202, and the mail body 203 are respectively similar to the message ID 401, the mail header 402, and the mail body 403 in the importance-determination request 400.

The backup server in use 204 is information indicating one or more of the backup servers 20 for use in saving the received email, where the one or more of the backup servers 20 are selected by the mail-server processing unit 112. In the example of FIG. 5, the email having the message ID “1” is saved in the two backup servers indicated by “store_svr1” and “store_svr2”.

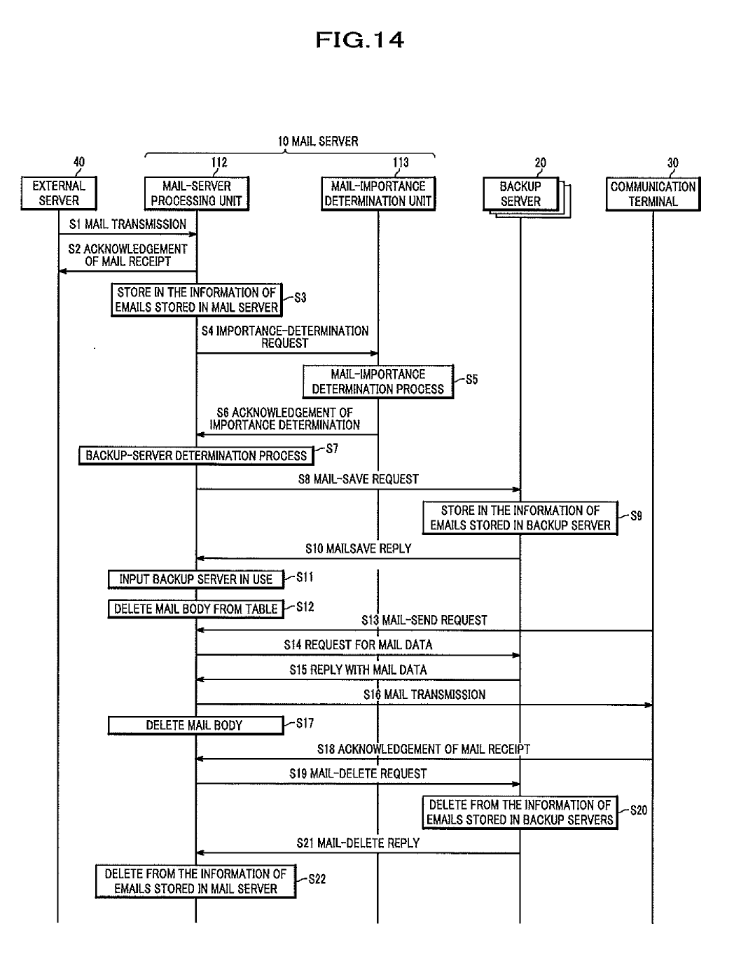

Incidentally, in the present embodiment, emails saved in the backup servers 20 are deleted from the mail-server-saved mail information 200 in the mail server 10 as explained later with reference to FIG. 14. In the example of FIG. 5, the emails having the message IDs “1” and “14” are saved in part of the backup servers 20. Therefore, the mail bodies 203 of the emails having the message IDs “1” and “14” are deleted from the mail-server-saved mail information 200, so that “-” is indicated in the fields of the mail body 203 for the emails having the message IDs “1” and “14” in FIG. 5.

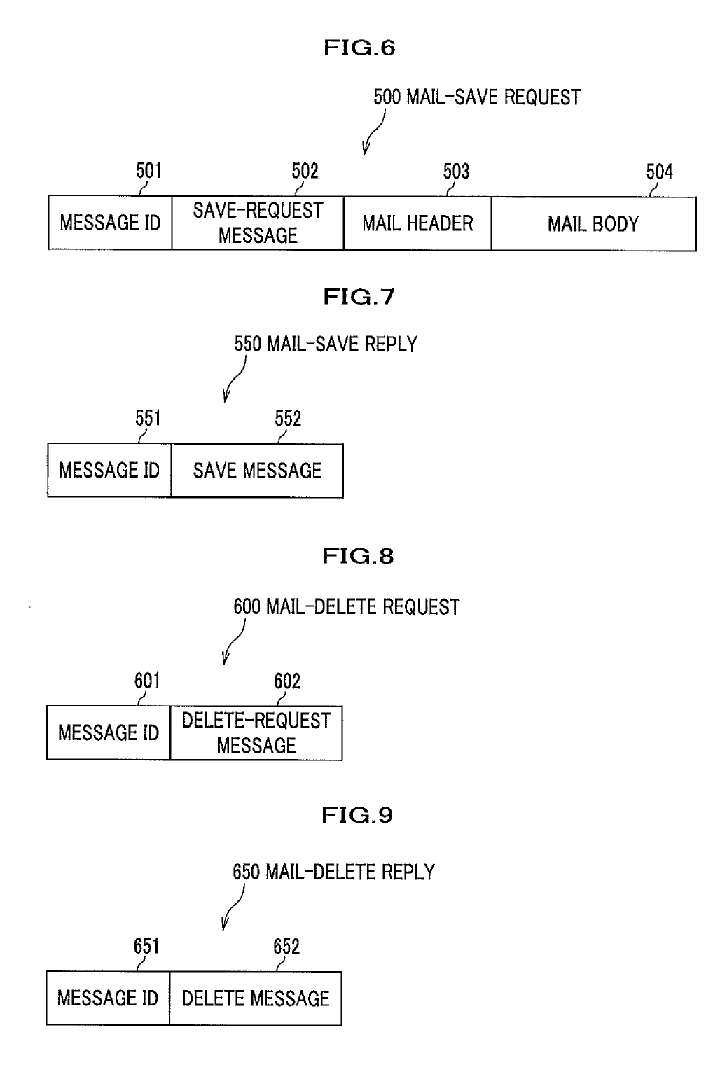

When the mail-server processing unit 112 selects the one or more of the backup servers 20 for use in saving the received email, the mail-server processing unit 112 sends a mail-save request 500 (as illustrated in FIG. 6) to each of the one or more of the backup servers 20. Thereafter, the mail-server processing unit 112 receives from each of the one or more of the backup servers 20 a mail-save reply 550 for confirmation that the backup server saves the received email.

When transmission of an email to one of the communication terminals accommodated by the mail server 10 (e.g., the communication terminal 30) is completed, the mail-server processing unit 112 sends a mail-delete request 600 (as illustrated in FIG. 8) to each of one or more of the backup servers 20 in which the email is saved. Thereafter, the mail-server processing unit 112 receives from each of the one or more backup servers a mail-delete reply 650 for confirmation that the saved email is deleted from the backup server.

FIG. 6 illustrates an example of a format of the mail-save request 600 in the present embodiment, and FIG. 7 illustrates an example of a format of the mail-save reply 650 in the present embodiment.

As illustrated in FIG. 6, the format of the mail-save request 600 includes the fields of a message ID 601, a save-request message 602, a mail header 603, and a mail body 604. The field of the message ID 601 contains a message ID of an email which is to be saved. The save-request message 602 is an indication that the message is a mail-save request, which is represented by “0” and/or “1” bits.

As illustrated in FIG. 7, the mail-save reply 650 includes the fields of a message ID 651 and a save message 652. The field of the message ID 651 contains a message ID of the saved email. The save message 652 is an indication that the message is a mail-save reply and saving of the email is completed. The indication is represented by “0” and/or “1” bits.

FIG. 8 illustrates an example of a format of the mail-delete request 600 in the present embodiment, and FIG. 9 illustrates an example of a format of the mail-delete reply 650 in the present embodiment.

As illustrated in FIG. 8, the format of the mail-delete request 600 includes the fields of a message ID 601 and a delete-request message 602. The field of the message ID 601 contains a message ID of an email which is to be deleted. The delete-request message 602 is an indication that the message is a mail-delete request, and the indication is represented by “0” and/or “1” bits.

As illustrated in FIG. 9, the mail-delete reply 650 includes the fields of a message ID 651 and a delete message 652. The field of the message ID 651 contains a message ID of the deleted email. The delete message 652 is an indication that the message is a mail-delete reply and deletion of the email is completed. The indication is represented by “0” and/or “1” bits.

Further, the mail-server processing unit 112 stores as operation-log information 141 in the storage unit 140 a log of operations including saving, update, deletion, and the like of the respective information items in the mail-server-saved mail information 200.

Referring back to FIG. 1, when the mail-importance determination unit 113 receives the importance-determination request 400 (illustrated in FIG. 3) from the mail-server processing unit 112, the mail-importance determination unit 113 refers to the mail-importance determination table 300 stored in the memory unit 130, and determines the degree of importance of the received email. At this time, the mail-importance determination unit 113 determines the degree of importance of the received email to be one of the three degrees of importance, “Important”, “Spam”, “General”. Thereafter, the mail-importance determination unit 113 outputs the result of the determination to the mail-server processing unit 112 in the form of the importance-determination reply 450 (illustrated in FIG. 4).

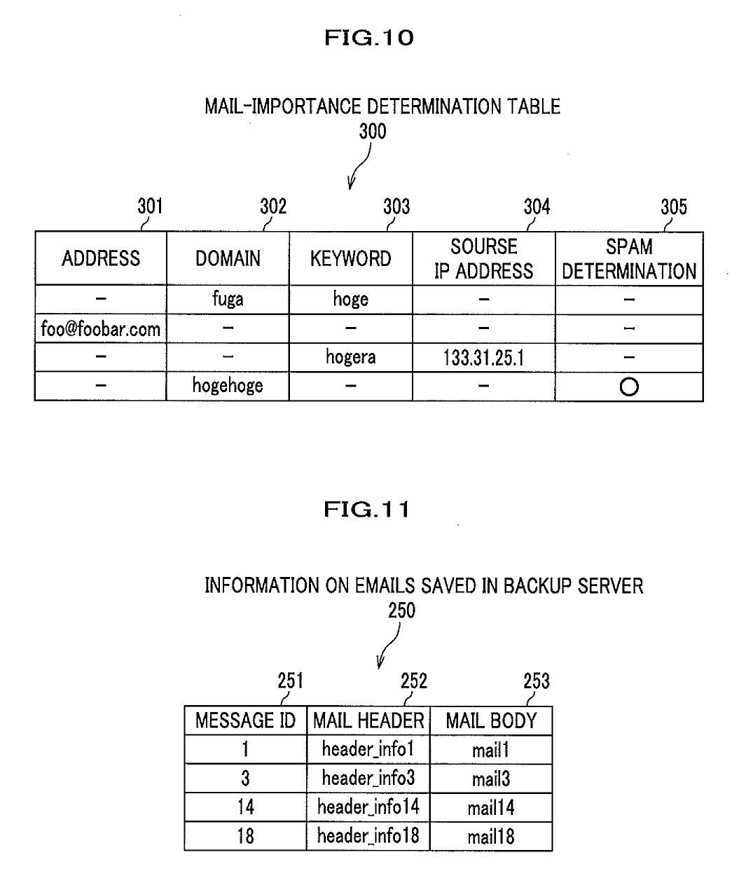

FIG. 10 illustrates an example of a data structure in the mail-importance determination table 300 used in the present embodiment. The mail-importance determination table 300 contains a record for each of the received emails, and each record is constituted by the fields of an address 301, a domain 302, a keyword 303, a source IP address 304, and a spam determination 305. Each record indicates a condition for determining whether or not the degree of importance of each received email is “Important” or whether or not the degree of importance of each received email is “Spam”. The mail-importance determination table 300 is assumed to be set in advance by an administrator of the mail server 10.

The address 301, the domain 302, the keyword 303, and the source IP address 304 are information items which are used as criteria for determining the degree of importance. Specifically, in the field of the address 301, the source mail address or the destination mail address is stored. In the field of the domain 302, a domain name is stored. In the field of the keyword 303, a keyword is stored. The mail-importance determination unit 113 searches the mail body for the keyword set in the keyword 303. In the field of the source IP address 304, the source IP address of the received email is stored. In the field of the spam determination 305, “YES” is indicated when the received email is determined to be a spam mail.

The mail-importance determination unit 113 refers to the mail-importance determination table 300, and determines the degree of importance of the received email to be “Spam” when the received email matches the condition indicated in the information items 301 to 304 in one of the records having the “YES” indication for the spam determination in the field 305. For example, the mail-importance determination unit 113 determines the degree of importance of the received email to be “Spam” when the received email has the domain name “hogehoge”, since the domain name “hogehoge” is indicated in the field 302 in the record having the “YES” indication for the spam determination in the field 305.

On the other hand, when the received email matches the condition indicated in the information items 301 to 304 in one of the records having no indication for the spam determination in the field 305, the mail-importance determination unit 113 determines the degree of importance of the received email to be “Important”. For example, the mail-importance determination unit 113 determines the degree of importance of the received email to be “Important” when the received email has the domain name “fuga” and the mail body of the received email is determined by a search of the mail body to contain the keyword “hoge”, since the domain name “fuga” and the keyword “hoge” are respectively indicated in the fields 302 and 303 in one of the records having no indication for the spam determination in the field 305.

Further, when the received email does not match the condition indicated in the information items 301 to 304 in any of the records contained in the mail-importance determination table 300, the mail-importance determination unit 113 determines the degree of importance of the received email to be “General”.

Referring back to FIG. 1, the input/output unit 120 is constituted by a communication interface and an input/output interface. The communication interface is provided for sending and receiving information to and from the backup servers 20 through a LAN or a WAN, and to and from the communication terminals accommodated by the mail server 10 (including the communication terminal 30) and the external servers (including the external server 40) through the network 50, and the input/output interface is provided for receiving information from input devices such as a keyboard and a mouse (which are not shown) and outputting information to output devices such as a display device (which are not shown).

The memory unit 130 is constituted by one or more storage devices such as a RAM (random access memory), and stores the backup-server management table 100, the mail-server-saved mail information 200, the mail-importance determination table 300, and other information.

The storage unit 140 is constituted by one or more storage devices such as a hard disk drive or a flash memory, and stores the operation-log information 141 (as the record of the operations such as saving and deletion of emails). In addition, the storage unit 140 stores one or more programs for performing the operations of the control unit 110.

The functions of the control unit 110 can be realized, for example, by loading the one or more programs stored in the storage unit 140 on the memory unit 130 by a CPU (central processing unit) and executing the one or more programs by the CPU.

### 3. Backup Servers

Hereinbelow, the backup servers 20 (20A, 20B, 20C . . . ) are explained.

When each of the backup servers 20 receives a mail-save request 500 (as illustrated in FIG. 6) from the mail server 10, the backup server makes a backup of an email received by the mail server 10 by saving the email in the backup server. Each of the backup servers 20 includes a control unit 210, an input/output unit 220, a memory unit 230, and a storage unit 240.

The control unit 210 includes the backup-server information management unit 211 and the backup-server processing unit 212, and controls all the operations for saving (backing up) emails.

When each of the backup servers 20 is started up, the backup-server information management unit 211 in the backup server sends, through the input/output unit 220 to the backup-server monitoring unit 111 in the mail server 10, the lower threshold 106, the upper threshold 107, the host name 101, and the IP address 102 which are stored in the storage unit 240 in the backup server. At this time, the backup-server information management unit 211 may also send to the backup-server monitoring unit 111 information on the total memory capacity in the backup server.

In addition, the backup-server information management unit 211 sends the service status 104 and the memory usage 105 to the backup-server monitoring unit 111 in the mail server 10 at predetermined intervals.

When each of the backup servers 20 receives a mail-save request 500 (as illustrated in FIG. 6) from the mail server 10, the backup-server processing unit 212 in the backup server stores information on the email requested to be backed up, as part of backup-server-saved mail information 250 in the memory unit 230. The backup-server-saved mail information 250 is information on emails saved in each of the backup servers. Then, the backup-server processing unit 212 sends a mail-save reply 550 (as illustrated in FIG. 7) to the mail server 10 for confirmation of the saving of the email.

FIG. 11 illustrates an example of a format of the backup-server-saved mail information 250 in the present embodiment. The backup-server-saved mail information 250 contains a record for each of the received emails, and each record is constituted by the fields of a message ID 251, a mail header 252, and a mail body 253.

When each of the backup servers 20 receives a mail-delete request 600 (as illustrated in FIG. 8) from the mail server 10, the backup-server processing unit 212 searches the backup-server-saved mail information 250 (as illustrated in FIG. 11) in the memory unit 230 by using as a key the message ID 601 contained in the received mail-delete request 600, and deletes from the backup-server-saved mail information 250 the record having the message ID 251 identical to the message ID 601. Then, the backup-server processing unit 212 sends to the mail server 10 a mail-delete reply 650 (as illustrated in FIG. 9) for confirmation of the deletion of the saved email.

The backup-server processing unit 212 stores as operation-log information 241 in the storage unit 240 a log of operations including saving, update, deletion, and the like of the respective information items in the backup-server-saved mail information 250.

Referring back to FIG. 1, the input/output unit 220 is constituted by a communication interface and an input/output interface. The communication interface is provided for sending and receiving information to and from the mail server 10 through a communication network, and the input/output interface is provided for receiving information from input devices such as a keyboard and a mouse (which are not shown) and outputting information to output devices such as a display device (which are not shown).

The memory unit 230 is constituted by one or more storage devices such as a RAM (random access memory), and stores the backup-server-saved mail information 250 (as illustrated in FIG. 11) and other information.

The storage unit 240 is constituted by one or more storage devices such as a hard disk drive or a flash memory, and stores the operation-log information 241 (as the record of the operations such as saving and deletion of emails). In addition, the storage unit 240 stores one or more programs for performing the operations of the control unit 210.

The functions of the control unit 210 in each of the backup servers 20 can be realized, for example, by loading the one or more programs stored in the storage unit 240 on the memory unit 230 by a CPU (central processing unit), and executing the one or more programs by the CPU.

### 4. Backup Method

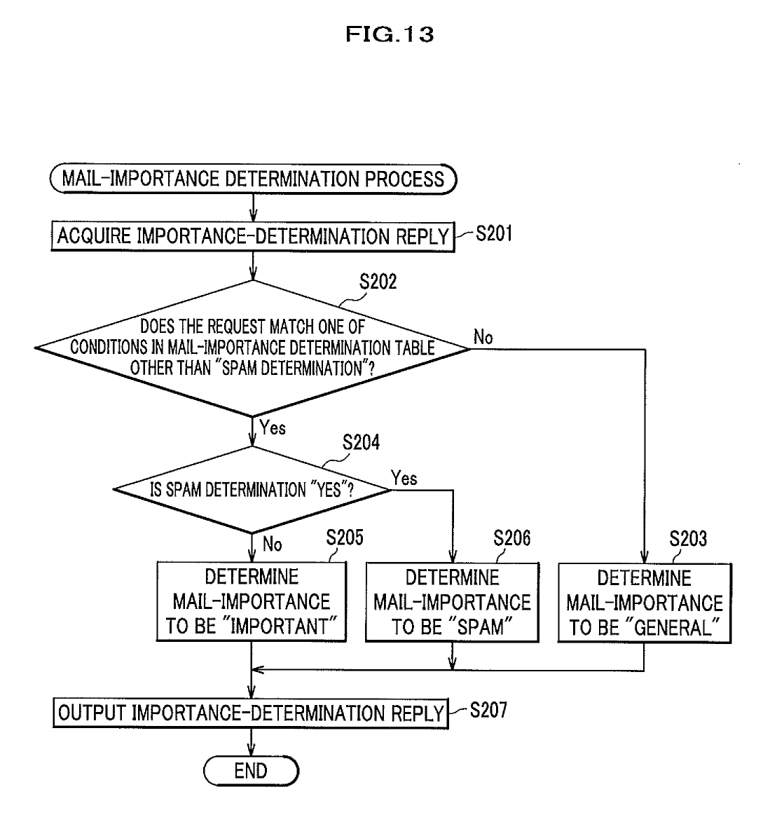

Hereinbelow, a method for backing up an email received by the mail server 10 according to the present embodiment is explained in detail. The aforementioned backup-server determination processing, which is performed by the mail-server processing unit 112, is first explained with reference to FIG. 12, and then processing for determining the degree of importance of an email, which is performed by the mail-importance determination unit 113, is explained with reference to FIG. 13. (Hereinafter, the processing for determining the degree of importance of an email may be referred to as the mail-importance determination processing.) Thereafter, a flow of the entire processing performed by the mail system 1 according to the present embodiment is explained with reference to FIG. 14.

### 4.1 Backup-server Determination Processing

FIG. 12 is a flow diagram indicating a flow of operations in the backup-server determination processing performed by the mail-server processing unit 112 in the mail server 10 in the present embodiment. In the backup-server determination processing, the number of one or more backup servers for use in saving an email received from an external server (e.g., the external server 40) is determined, and one or more of the backup servers 20 for use in saving the received email are selected.

In step S101, the mail-server processing unit 112 in the mail server 10 receives an email from the external server 40 through the input/output unit 120.

In step S102, in order to determine the degree of importance of the received email, the mail-server processing unit 112 outputs an importance-determination request 400 (as illustrated in FIG. 3) to the mail-importance determination unit 113. Then, in step S103, the mail-server processing unit 112 receives an importance-determination reply 450 (as illustrated in FIG. 4) from the mail-importance determination unit 113, where the importance-determination reply 450 contains a result of a determination of the degree of importance of the email.

Subsequently, in step S104, the mail-server processing unit 112 refers to the backup-server management table 100 (as illustrated in FIG. 2), and acquires the connection status 103 indicating whether or not each of the backup servers 20 is connectable, the service status 104 indicating whether or not each of the backup servers 20 can make a backup, and the memory usage 105 in each of the backup servers 20.

Then, in step S105, the mail-server processing unit 112 determines whether or not the connection status 103 of each of the backup servers 20 is “Connect” and whether or not the service status 104 of each of the backup servers 20 is “Service” (i.e., whether or not each of the backup servers 20 can currently make a backup), and determines whether or not the memory usage 105 in every backup server having the connection status of “Connect” and the service status of “Service” is below the lower threshold 106.

When the mail-server processing unit 112 determines in step S105 that the memory usage 105 in every backup server having the connection status of “Connect” and the service status of “Service” is below the lower threshold 106 (i.e., when yes is determined in step S105), every backup server having the connection status of “Connect” and the service status of “Service” is determined to have a sufficient memory area, so that the operation goes to step S106

In step S106, the mail-server processing unit 112 determines the number of one or more backup servers for use in saving of the received email on the basis of the degree of importance obtained in step S103. Specifically, the mail-server processing unit 112 determines the number of one or more backup servers to be i when the degree of importance is “Important”, to be j when the degree of importance is “General”, and to be k when the degree of importance is “Spam”, where i, j, and k are integers satisfying i≧j≧k.

When the mail-server processing unit 112 determines in step S105 that the memory usage 105 in at least one backup server having the connection status of “Connect” and the service status of “Service” is equal to or greater than the lower threshold 106 (i.e., when No is determined in step S105), the operation goes to step S107.

In step S107, the mail-server processing unit 112 determines whether or not at least one backup server having the connection status of “Connect” and the service status of “Service” has the memory usage 105 exceeding the upper threshold 107.

When the mail-server processing unit 112 determines in step S107 that no backup server having the connection status of “Connect” and the service status of “Service” has the memory usage 105 exceeding the upper threshold 107 (i.e., when no is determined in step S107), the operation goes to step S108.

In step S108, the mail-server processing unit 112 determines the number of one or more backup servers for use in saving of the received email on the basis of the degree of importance obtained in step S103. Specifically, the mail-server processing unit 112 determines the number of one or more backup servers to be i′ when the degree of importance is “Important”, to be j′ when the degree of importance is “General”, and to be k′ when the degree of importance is “Spam”, where i′, j′, and k′ are integers satisfying i′≧j′≧k′.

When the mail-server processing unit 112 determines in step S107 that at least one backup server having the connection status of “Connect” and the service status of “Service” has the memory usage 105 exceeding the upper threshold 107 (i.e., when yes is determined in step S107), the operation goes to step S109.

In step S109, the mail-server processing unit 112 determines the number of one or more backup servers for use in saving of the received email on the basis of the degree of importance obtained in step S103. Specifically, the mail-server processing unit 112 determines the number of one or more backup servers to be i″ when the degree of importance is “Important”, to be j″ when the degree of importance is “General”, and to be k″ when the degree of importance is “Spam”, where i″, j″, and k″ are integers satisfying i″≧j″≧k″.

The above integers i, j, k, j′, k′, i″, j″, and k″ are preset so as to further satisfy the relationships, i≧i′≧i″, j≧j′≧j″, and k≧k′≧k″, on the basis of the principle that the number of one or more backup servers is increased with the degree of importance, and decreased with the available space in the memory. The purpose of the reduction of the number of one or more backup servers with the available space in the memory is to prevent occurrence of congestion which can be caused by memory shortage.

After the number of one or more backup servers for use in saving the received email is determined in steps S106, S108, and S109, the mail-server processing unit 112 selects, in step S110, one or more of the backup servers 20 in the determined number for use in saving the received email.

At this time, the one or more of the backup servers 20 are selected in increasing order of the memory usage 105. Alternatively, in the case where the backup-server management table 100 (as illustrated in FIG. 2) in the mail server 10 further stores the total memory capacity in each of the backup servers 20, the one or more of the backup servers 20 may be selected in decreasing order of the available space of the memory or in increasing order of the proportion of the memory usage to the total memory capacity. For example, the manner of selection of the one or more of the backup servers 20 can be set in the mail-server processing unit 112 by storing a selection logic program in the storage unit 140 in the mail server 10 in advance, and reading the selection logic program from storage unit 140 when the mail server 10 is started up.

Subsequently, in step S111, the mail-server processing unit 112 sends a mail-save request 500 (as illustrated in FIG. 6) to the one or more of the backup servers 20 selected in step S110.

As explained above, the mail-server processing unit 112 in the mail server 10 can determine the number of one or more backup servers for use in saving each email, and select one or more of the backup servers 20 for use in saving the email.

### 4.2 Mail-Importance Determination Processing

Next, the mail-importance determination processing performed by the mail server 10 according to the present embodiment is explained below.

FIG. 13 indicates a flow of operations in the mail-importance determination processing performed by the mail-importance determination unit 113 in the mail server 10 in the present embodiment.

First, in step S201, the mail-importance determination unit 113 in the mail server 10 receives an importance-determination request 400 (as illustrated in FIG. 3) from the mail-server processing unit 112.

In step S202, the mail-importance determination unit 113 searches the mail-importance determination table 300 (as illustrated in FIG. 10) on the basis of the mail header 402 and the mail body 403 contained in the received importance-determination request 400, and determines whether or not the received email matches the condition constituted by the information items (301 to 304) other than the spam determination 305 in one of the records in the mail-importance determination table 300.

When the mail-importance determination unit 113 determines, in step S202, that the received email does not match the condition constituted by the information items (301 to 304) other than the spam determination 305 in any of the records in the mail-importance determination table 300 (i.e., when no is determined in step S202), the operation goes to step S203, in which the mail-importance determination unit 113 determines the degree of importance of the email to be “General”.

When the mail-importance determination unit 113 determines, in step S202, that the received email matches the condition constituted by the information items (301 to 304) other than the spam determination 305 in one of the records in the mail-importance determination table 300 (i.e., when yes is determined in step S202), the operation goes to step S204.

In step S204, the mail-importance determination unit 113 determines whether or not “YES” is indicated in the field of the spam determination 305 in the record in which the match is determined in step S202.

When “YES” is not indicated in the field of the spam determination 305 in the record in which the match is determined in step S202 (i.e., when no is determined in step S204), the mail-importance determination unit 113 determines the degree of importance to be “Important” in step S205. When “YES” is indicated in the field of the spam determination 305 in the record in which the match is determined in step S202 (i.e., when yes is determined in step S204), the mail-importance determination unit 113 determines the degree of importance to be “Spam” in step S206.

After the degree of importance is determined in steps S203, S205, and S206, the mail-importance determination unit 113 outputs an importance-determination reply 450 (as illustrated in FIG. 4) to the mail-server processing unit 112 in step S207, where the importance-determination reply 450 contains the determined degree of importance of the email.

As explained above, the mail-importance determination unit 113 in the mail server 10 can determine the degree of importance of each email by reference to the mail-importance determination table 300.

### 4.3 Processing Performed in Entire System

Next, a sequence of processing performed in the entire mail system 1 according to the present embodiment is explained below.

FIG. 14 indicates a sequence of operations performed in the entire mail system 1 containing the mail server 10 and the backup servers 20 in the present embodiment. In the sequence of FIG. 14, an email from a source (e.g., a communication terminal connected to the external server 40) is received by the mail server 10, and is then saved in one or more of the backup servers 20. Thereafter, an email is sent to a communication terminal (e.g., the communication terminal 30) which requests the email. In the following explanations, it is assumed that the backup-server monitoring unit 111 monitors the backup servers 20 (20A, 20B, 20C . . . ), and information on each of the backup servers 20 is already stored in the backup-server management table 100 (as illustrated in FIG. 2).

First, in step S1, an email is transmitted from the external server 40 through the network 50 to the mail server 10. When the mail server 10 receives the email, the mail-server processing unit 112 sends an acknowledgement of mail receipt to the external server 40 in step S2. Then, in step S3, the mail-server processing unit 112 stores information on the received email as part of the mail-server-saved mail information 200 (as illustrated in FIG. 5).

Next, in step S4, the mail-server processing unit 112 in the mail server 10 outputs to the mail-importance determination unit 113 an importance-determination request 400 (as illustrated in FIG. 3) for the received email. When the mail-importance determination unit 113 receives the importance-determination request 400, in step S5, the mail-importance determination unit 113 performs the mail-importance determination processing by reference to the mail-importance determination table 300 (as illustrated in FIG. 10), and determines the degree of importance of the email to be one of “Important”, “General”, and “Spam”. Then, in step S6, the mail-importance determination unit 113 outputs to the mail-server processing unit 112 an importance-determination reply 450 (as illustrated in FIG. 4), which contains the result of the determination of the degree of importance.

When the mail-server processing unit 112 receives the importance-determination reply 450, the mail-server processing unit 112 performs the backup-server determination processing in step S7. Specifically, the mail-server processing unit 112 determines the number of one or more backup servers for use in saving the email, and then determines one or more of the backup servers 20 for use in saving the email, on the basis of the degree of importance of the email determined by the mail-importance determination unit 113 and the information in the backup-server management table 100 (as illustrated in FIG. 2).

Subsequently, in step S8, the mail-server processing unit 112 sends a mail-save request 500 (as illustrated in FIG. 6) to each of the one or more backup servers which are determined for use in saving the email. When each of the one or more backup servers determined for use in saving the email receives the mail-save request 500, the backup-server processing unit 212 in the backup server stores information on the received email as part of the backup-server-saved mail information 250 (illustrated in FIG. 11) in the memory unit 230 in step S9. Then, the backup-server processing unit 212 sends a mail-save reply 550 (illustrated in FIG. 7) to the mail server 10 in step S10.

When the mail server 10 receives the mail-save reply 550 from each of the one or more of the backup servers 20, the mail-server processing unit 112 in the mail server 10 inputs information indicating the backup server as the information indicating the backup server in use into the field 204 in the record for the email in the mail-server-saved mail information 200 (illustrated in FIG. 5) in step S11. When the mail server 10 receives the mail-save reply 550 from all of the one or more of the backup servers 20, the mail-server processing unit 112 deletes the information (i.e., the mail body) in the field 203 in the record for the email from the mail-server-saved mail information 200 in step S12.

Thereafter, when the mail server 10 receives a mail-send request (for an email) from, for example, the communication terminal 30 in step S13, the mail-server processing unit 112 in the mail server 10 refers to the backup server in use 204 in the mail-server-saved mail information 200, and sends a request for mail data to one of one or more backup servers which save the email, in step S14. At this time, in the case where the email is saved in multiple backup servers, the request for mail data may be sent to a randomly selected one of the more than one backup server which saves the email. Alternatively, in the case where priorities are respectively assigned to the multiple backup servers, the request for mail data may be sent to one of the multiple backup servers to which a high priority is assigned.

When the one of one or more backup servers which save the email receives the request for mail data, the backup-server processing unit 212 in the backup server acquires information on the corresponding email from the backup-server-saved mail information 250 (illustrated in FIG. 11), and sends to the mail server 10 the acquired information as a reply with mail data, in step S15.

When the mail server 10 receives the reply with mail data, the mail-server processing unit 112 in the mail server 10 sends the corresponding email to the communication terminal 30 in step S16 and the mail-server processing unit 112 deletes the mail body in step S17. When the communication terminal 30 receives the email, the communication terminal 30 sends an acknowledgement of mail receipt to the mail server 10 in step S18.

The deletion of the mail body 203 in step S12 is performed for minimizing the memory usage in the mail server 10. However, it is possible to omit the deletion in step S12. In this case, the operations in step S14 and S15 are not performed, and the mail body 203 saved in the mail server 10 is deleted after the acknowledgement of mail receipt is received in step S18 or S21 (i.e., the operation in step S17 is not performed).

When the mail server 10 receives the acknowledgement of mail receipt from the communication terminal 30, the mail-server processing unit 112 in the mail server 10 sends, to each of the one or more of the backup servers 20 saving the corresponding email, a mail-delete request 600 (as illustrated in FIG. 8) for requesting deletion of the information on the corresponding email in step S19. When each of the one or more of the backup servers 20 saving the corresponding email receives the mail-delete request 600, the backup-server processing unit 212 in the backup server deletes the information on the corresponding email from the backup-server-saved mail information 250 (illustrated in FIG. 11) in step S20. Then, the backup-server processing unit 212 sends a mail-delete reply 650 (as illustrated in FIG. 9) to the mail server 10 in step S21. When the mail server 10 receives the mail-delete reply 650 from each of the one or more of the backup servers 20 which have been used for saving the corresponding email, the mail-server processing unit 112 in the mail server 10 deletes the information on the corresponding email from the mail-server-saved mail information 200 (illustrated in FIG. 5) in step S22, and the processing of FIG. 14 is completed.

Since the mail saving-and-backup system according to the present embodiment is configured and operates as explained above, and the backup method according to the present embodiment is performed as explained above, it is possible to determine the degree of importance of each email received by the mail server, and determine the number of one or more backup servers for use in saving the email and one or more of the backup servers for use in saving the email, on the basis of the determined degree of importance and the status information (including the memory usage) acquired from each backup server. Therefore, the mail saving-and-backup system and the backup method according to the present embodiment can enhance the efficiency in email storage while ensuring the failure tolerance in email saving.

What is claimed is:

1. A mail saving-and-backup system comprising;
a mail server for managing transmission and reception of emails; and
a plurality of backup servers for backing up emails received by the mail server;
wherein the mail server includes,
a first memory unit which stores backup-server management information including information on current status of each of the plurality of backup servers, where the information on the current status includes current memory usage in each of the plurality of backup servers,
a backup-server monitoring unit which acquires the information on the current status from each of the plurality of backup servers, and stores the information on the current status as part of the backup-server management information,
a mail-importance determination unit which determines a degree of importance of an email received by the mail server, where the degree of importance is an index for determining whether or not the email is to be preferentially saved in the plurality of backup servers, and
a mail-server processing unit which determines the number of one or more backup servers for use in saving the email, on the basis of the degree of importance and the current memory usage included in the information on the current status, selects one or more of the plurality of backup servers in the determined number for use in saving the email, and sends the email to each of the one or more of the plurality of backup servers, and
each of the plurality of backup servers includes,
a second memory unit,
a backup-server information management unit which sends the information on the current status to the mail server, and
a backup-server processing unit which receives the email from the mail server, and stores the email in the second memory unit.

2. The mail saving-and-backup system according to claim 1, wherein in the mail server, a lower threshold and an upper threshold are stored for each of the plurality of backup servers as part of the backup-server management information in the first memory unit, the lower threshold is a threshold to be used for determining whether or not the current memory usage is sufficiently smaller than a total memory capacity in each of the plurality of backup servers, the upper threshold is a threshold for determining whether or not the current memory usage is considerably close to the total memory capacity in each of the plurality of backup servers, the mail-server processing unit determines whether or not the current memory usage in every one of the plurality of backup servers falls below the lower threshold, determines whether or not the current memory usage in at least one of the plurality of backup servers exceeds the upper threshold in the case where it is determined that the current memory usage in at least one of the plurality of backup servers is equal to or greater than the lower threshold, and determines the number of one or more backup servers in such a manner that the number of one or more backup servers determined in the case where the current memory usage in at least one of the plurality of backup servers exceeds the upper threshold is equal to or smaller than the number of one or more backup servers determined in the case where the current memory usage in every one of the plurality of backup servers falls below the lower threshold.

3. The mail saving-and-backup system according to claim 1, wherein the mail-server processing unit determines the number of one or more backup servers in such a manner that the number of one or more backup servers for use in saving is increased with the degree of importance.

4. The mail saving-and-backup system according to claim 1, wherein the mail-server processing unit selects the one or more of the plurality of backup servers for saving the email in increasing order of the current memory usage.

5. A backup method performed in a mail saving-and-backup system including,
a mail server which manages transmission and reception of emails and includes a first memory unit storing backup-server management information including information on current status of each of a plurality of backup servers, where the information on the current status includes current memory usage in each of the plurality of backup servers, and
the plurality of backup servers each of which can back up emails received by the mail server and includes a second memory unit;
the backup method comprises the steps of:
sending, the information on the current status from each of the plurality of backup servers to the mail server;
acquiring, by the mail server, the information on the current status from each of the plurality of backup servers, and storing the information on the current status as part of the backup-server management information in the first memory unit;
receiving an email by the mail server;
determining, by the mail server, a degree of importance of the email received by the mail server, where the degree of importance is an index for determining whether or not the email is to be preferentially saved in the plurality of backup servers;
determining, by the mail server, the number of one or more backup servers for use in saving the email, on the basis of the degree of importance and the current memory usage included in the information on the current status;
selecting, by the mail server, one or more of the plurality of backup servers in the determined number for use in saving the email;
sending the email from the mail server to each of the one or more of the plurality of backup servers; and
receiving, by each of the one or more of the plurality of backup servers, the email from the mail server, and storing the email in the second memory unit in each of the one or more of the plurality of backup servers.

6. The backup method according to claim 5, wherein a lower threshold and an upper threshold are stored for each of the plurality of backup servers as part of the backup-server management information in the first memory unit in the mail server, the lower threshold is a threshold to be used for determining whether or not the current memory usage is sufficiently smaller than a total memory capacity in each of the plurality of backup servers, the upper threshold is a threshold for determining whether or not the current memory usage is considerably close to the total memory capacity in each of the plurality of backup servers, and the step of determining the number of one or more backup servers includes the substeps of: determining whether or not the current memory usage in every one of the plurality of backup servers falls below the lower threshold, determining whether or not the current memory usage in at least one of the plurality of backup servers exceeds the upper threshold in the case where it is determined that the current memory usage in at least one of the plurality of backup servers is equal to or greater than the lower threshold, and determining the number of one or more backup servers in such a manner that the number of one or more backup servers determined in the case where the current memory usage in at least one of the plurality of backup servers exceeds the upper threshold is equal to or smaller than the number of one or more backup servers determined in the case where the current memory usage in every one of the plurality of backup servers falls below the lower threshold.

7. The backup method according to claim 5, wherein in the step of determining the number of one or more backup servers, the number of one or more backup servers is determined in such a manner that the number of one or more backup servers for use in saving is increased with the degree of importance.

8. The backup method according to claim 5, wherein in the step of selecting, the one or more of the plurality of backup servers for saving the email are selected in increasing order of the current memory usage.
